(19) United States
(12) Patent Application Publication
(10) Pub. No.: US 2026/0360361 A1
(43) Pub. Date: Nov. 12, 2026

(54) DIGITAL INTERFACE WITH USER INPUT GUIDANCE BASED ON STRUCTURED DATA

(71) Applicant: MagicX Inc., Burlingame, CA (US)

(72) Inventors: Bradley Kowalk, San Francisco, CA (US); Seung Woo Lee, Belmont, CA (US)

(21) Appl. No.: 19/746,094

(22) Filed: Jul. 17, 2026

Related U.S. Application Data
(63) Continuation-in-part of application No. 19/289,119, filed on Aug. 4, 2025.
Application No. 19/289,119 is a continuation of application No. 18/329,030, filed on Jun. 5, 2023, now Pat. No. 12,400,653.
(60) Provisional application No. 63/350,416, filed on Jun. 9, 2022.

(51) Int. Cl. G10L 15/22; G06F 3/0482; G06F 3/16; G10L 15/18; G10L 15/30

(52) U.S. Cl. CPC G10L 15/22; G06F 3/0482; G06F 3/167; G10L 15/18; G10L 15/30; G10L 2015/223

(57) ABSTRACT

A system receives a first user input from a client device and identifies an action associated with the first user input. The system accesses a command category associated with the identified action and representing a characteristic of the identified action. The system generates an interface for display on the client device that includes first user input and a set of placeholder text identifying the command category. The system receives a second user input corresponding to the command category from the client device and modifies the set of placeholder text based on the second user input. The system enables the client device for performing the identified action based at least on the modified set of placeholder text.

### CROSS-REFERENCE TO RELATED APPLICATIONS

This application is a continuation-in-part of U.S. application Ser. No. 19/289,119, filed Aug. 4, 2025, which is a continuation of U.S. application Ser. No. 18/329,030, filed Jun. 5, 2023, now U.S. Pat. No. 12,400,653, which claims a benefit of U.S. Provisional Application No. 63/350,416, filed Jun. 9, 2022, all of which are incorporated by reference herein in their entirety.

### TECHNICAL FIELD

The disclosure generally relates to the field of digital interfaces, and more generally, to a digital interface with user input guidance based on structured data.

### BACKGROUND

Computer assistants such as smart speakers and artificial intelligence programs are growing in popularity and in use in various user-facing systems. The computerized systems can often be implemented such that an entire process is automated without the human user of the system having any insight into the process. For example, a computer can complete a set of tasks without the need to display content to a screen for the user. However, many users prefer to receive feedback about a computerized process, and it is useful and necessary for a user to understand the state of a set of tasks if the user is needed to provide feedback at a particular step.

Conventional digital interfaces largely do not actively guide users in what to say in real-time apart from basic word autocompletion. This results in a large gap in expectations between what a user thinks they can or should say, and what inputs the system needs to accomplish a task.

Further, conventional digital interfaces generally do not predict next-word suggestions based on structured data of a third-party system with which the user is interacting. As a result, the suggestions presented to a user often do not correspond to actions, parameters, or options that are actually available in an application of the third-party system, and the suggestions cannot be readily translated into structured parameters that the application of the third-party system can act upon. Conventional systems thus fail to bridge the gap between a user's natural-language input and the structured data of the third-party system that the application of the third-party system would require to perform a corresponding action.

### BRIEF DESCRIPTION OF THE DRAWINGS

FIG. 1 is a high-level block diagram of a system architecture for a computing system, in accordance with an example embodiment.

FIG. 2 is a diagram of the interactions between components of the computing system, in accordance with an example embodiment.

FIG. 3A illustrates a first layout displayed for an interface associated with an order action, in accordance with an example embodiment.

FIG. 3B illustrates a second layout displayed for an interface, in accordance with an example embodiment.

FIG. 3C illustrates a third layout displayed for an interface, in accordance with an example embodiment.

FIG. 3D illustrates a fourth layout displayed for an interface, in accordance with an example embodiment.

FIG. 4A illustrates a first layout displayed for an interface associated with a third-party system, in accordance with an example embodiment.

FIG. 4B illustrates a second layout displayed for an interface associated with a third-party system, in accordance with an example embodiment.

FIG. 4C illustrates a third layout displayed for an interface associated with a third-party system, in accordance with an example embodiment.

FIG. 5 is a flowchart illustrating an example process of using a digital interface with user input guidance based on structured data, in accordance with an example embodiment.

FIG. 6 is a block diagram illustrating components of an example machine able to read instructions from a machine-readable medium and execute them in one or more processors (or controllers), in accordance with an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed are systems (as well as methods and computer program code stored on non-transitory computer readable mediums) configured to provide a digital interface with user guidance, which is capable of empowering users to i) know what they have said and/or what has been reorganized by the system; ii) know what they still need to input/say, e.g., parameters required by the system to complete a task; and iii) know what they can input/say, e.g., options for each parameter and optional parameters. In one embodiment, a digital interface receives a voice command from a client device and identifies an action associated with the voice command. The digital interface may access a set of command categories associated with the identified action, where each command category represents a characteristic of the identified action. The digital interface may generate an interface for display on the client device to include the first user input and a set of placeholder text identifying each of the command categories, and may receive a subsequent user input corresponding to one or more of the set of command categories. The digital interface may modify placeholder text corresponding to the one or more of the set of command categories with text corresponding to the subsequent user input, and can enable the client device to perform the identified action based at least on the modified placeholder text.

The digital interface described herein guides a user with what to say in real-time, with a continuously reinforcing framework (loop) of education and feedback techniques including, but not limited to, (i) guiding text and visuals, (ii) speech recognition/transcription, and (iii) speech understanding. In this way, the digital interface receives an entire set of instructions from the user before performing the action required by the user so that the digital interface does not perform an inapplicable or incomplete task for the user, resulting in i) fewer back and forth clarifying questions, and ultimately ii) a higher success rate.

The digital interface described herein may further guide the user based on the user's natural-language input and structured data associated with a third-party system with which the user is interacting. In some embodiments, the digital interface accesses hierarchically structured metadata from the third-party system, wherein the hierarchically structured metadata includes a plurality of command categories representing characteristics of actions performable via an application of the third-party system. The digital interface parses the hierarchically structured metadata to select one or more command categories corresponding to an action identified from the user's input, and generates an interface that includes a set of placeholder text identifying the selected command categories. As the user provides additional input selecting one or more of the command categories, the digital interface may extract further command categories that descend, in the hierarchically structured metadata, from the selected command categories, and update the interface to include the further command categories. As additional selections are received, the digital interface may further narrow the set of further command categories to a subset that descends from each of the selected command categories in the hierarchically structured metadata and may remove further command categories that are not in the subset from the interface. In this way, the digital interface allows a user to progressively narrow a natural language search for an action based on the hierarchically structured metadata of the third-party system.

In some embodiments, the modified set of placeholder text corresponding to a command category is associated with a key-value pair, where the command category as the key and the value is based on the user input. As additional user inputs are received for additionally selected command categories, additional key-value pairs may be generated and presented as a chain of the key-value pairs in the digital interface. In some embodiments, the chain of key-value pairs is ordered according to the path of command categories traversed through the hierarchically structured metadata. The chain of key-value pairs may be transmitted to the application of the third-party system to cause the application to perform the identified action. Thus, the digital interface described herein couples the user's natural-language input(s) to the structured data maintained by the third-party system to present suggestions and structured parameters that are directly actionable by the application of the third-party system.

### Example System Configuration

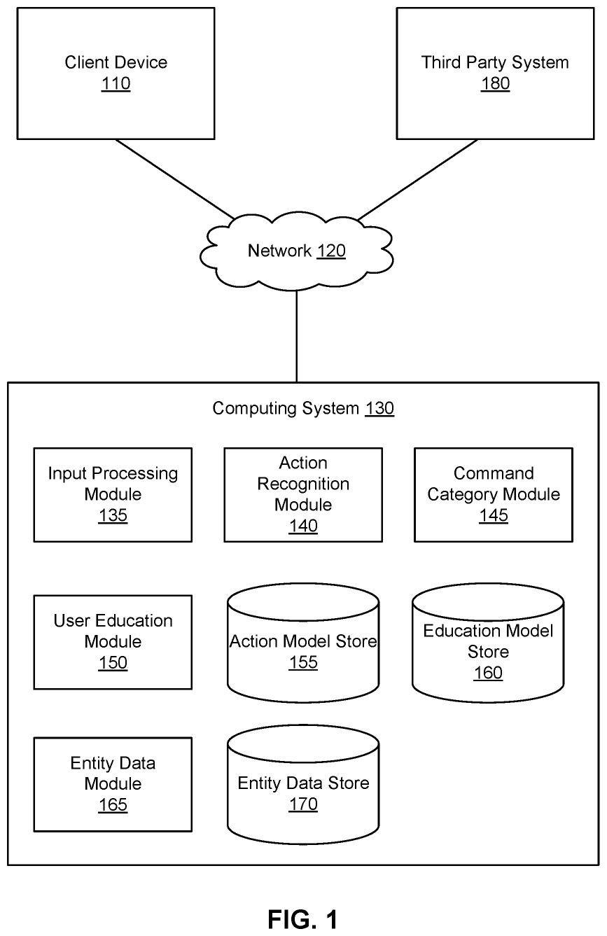

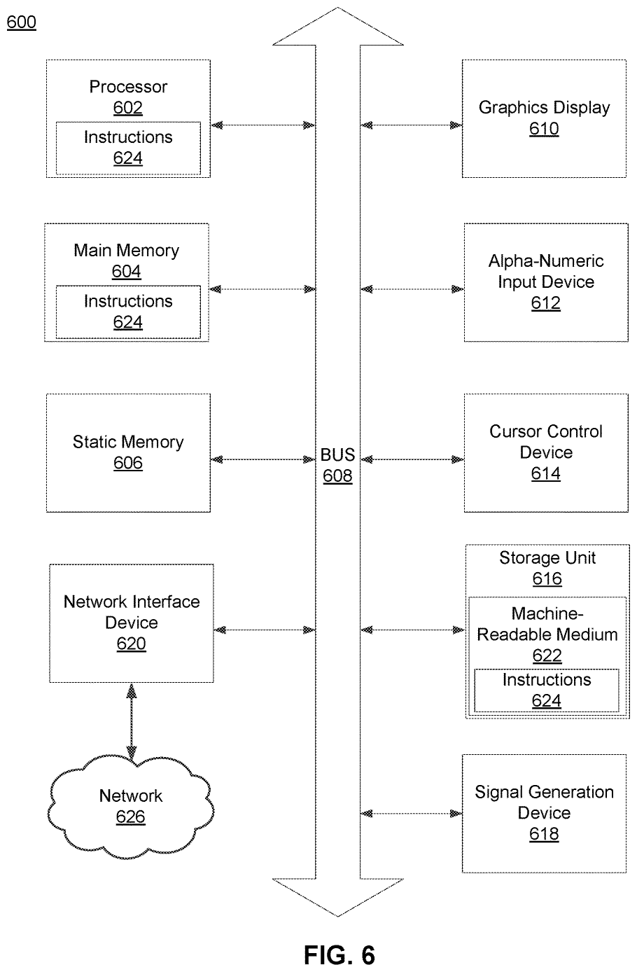

FIG. 1 is a block diagram of a system architecture for a computing system, in accordance with an example embodiment. FIG. 1 includes a computing system 130, a network 120, a client device 110, and a third party system 180. For clarity, only one client device and one computing system 130 is shown in FIG. 1. Alternate embodiments of the system environment can have any number of client devices 110 as well as multiple computing systems 130. The functions performed by the various entities of FIG. 1 may vary in different embodiments. The client device 110 and the computing system 130 may include some or all of the components of the example computing device described with FIG. 6, and likewise may include a corresponding operating system.

In an example embodiment, the computing system 130 generates (or renders or enables for rendering) a user interface for display to a user in response to user input (e.g., a typed or spoken text string). For example, the user input may include a voice command and/or text input, indicating an action to be performed by a digital interface. It should be noted that although the examples described herein related to voice commands, in practice the principles described herein apply equally to text inputs or any other natural language input. In some embodiments, the system may also receive visual input, e.g., from a camera or camera roll of a client device 110, to effectuate a search process on an online marketplace. The computing system 130 identifies an action associated with the user input. In some embodiments, the action corresponds to a machine (e.g., computer or computing system) prediction of what may be intended by a user based upon received user input. The action may be a computer executable function or request that corresponds to, and/or is described by, the received user input. The executable function may be instantiated by generating and/or populating (e.g., in a rendering) one or more user interfaces for the function that may be executed and that corresponds to what may be the identified action.

A user may enter a user input via a client device 110. Client devices 110 can be any personal or mobile computing devices such as smartphones, tablets, notebook computers, laptops, desktop computers, and smartwatches as well as any home entertainment device such as televisions, video game consoles, television boxes, and receivers. The client device 110 can present information received from the computing system 130 to a user, for example in the form of user interfaces. In some embodiments, the computing system 130 may be stored and executed from the same machine as the client device 110.

The client device 110 can communicate with the computing system 130 via the network 120. The network 120 may comprise any combination of local area and wide area networks employing wired or wireless communication links. In some embodiments, all or some of the communication of the network 120 may be encrypted.

The computing system 130 includes various modules and data stores to determine actions and the corresponding command categories, and/or generate interfaces. The computing system 130 comprises an input processing module 135, an action recognition module 140, a command category module 145, a user education module, an action model store 155, an education model store 160, an entity data module 165, and an entity data store 170. Computer components such as web servers, network interfaces, security functions, load balancers, failover servers, management and network operations consoles, and the like are not shown so as to not obscure the details of the system architecture. Additionally, the computing system 130 may contain more, fewer, or different components than those shown in FIG. 1 and the functionality of the components as described herein may be distributed differently from the description herein. It is noted that the module and modules may be embodied as program code (e.g., software or firmware), hardware (e.g., application specific integrated circuit (ASIC), field programmable gate array (FPGA), controller, processor) or a combination thereof.

The input processing module 135 receives user input, e.g., in the form of audio, and processes user input to generate signals that the computing system 130 can use for action recognition and for identifying command categories. In some embodiments, the input processing module 135 applies automatic speech recognition or other type of speech models to produce an input string that represents the input, e.g., as text. In one implementation, the input processing module 135 performs a natural language processing (NLP) operation on the received user input, for example, performing tokenization, part-of-speech tagging, stemming, lemmatization, stopword identification, dependency parsing, entity extraction, chunking, semantic role labeling, and coreference resolution. In one embodiment, the input to the input processing module 135 is a voice command including one or more words, for example, in the form of a complete or partially complete sentence or phrase. In some embodiments, the input processing module 135 constructs or looks up numerical representations or feature embeddings for immediate consumption by downstream modules that may use neural networks such as the action recognition module 140 or the command category module 145. For example, the input to the input processing module 135 may be a partial sentence and the output may be the partial sentence with accompanying metadata about the partial sentence.

In some embodiments, the input processing module 135 generates, from the received user input, a normalized rendering of the user input for display by the user education module 150. The input processing module 135 may generate the normalized rendering by modifying the received user input to correct a grammar, an ordering, or a style of the received user input while preserving its informational content. For example, the input processing module 135 may correct a spelling or grammatical error, reorder one or more words or phrases, or restyle the received user input into a standardized form; in response to receiving a user input of “can I Order a pza large,” the input processing module 135 may generate a normalized rendering of “Order a large pizza.” In some embodiments, the input processing module 135 applies a machine-learned model (e.g., a large language model or other generative language model) to generate the normalized rendering. The user education module 150 may display the normalized rendering in place of, or in addition to, the received user input.

The action recognition module 140 identifies an action based on the processed user inputs received from the user (via the client device 110). In particular, the action recognition module 140 may identify a function that the computing system 130 can perform. The action corresponds to the set of words identified from the processed user input. The user input may be matched to one or more pre-defined actions. For ease of discussion, the system is described in the context of words included in a voice command but, in some embodiments, may be used for other user inputs such as textual inputs or combined audio-textual inputs. However, it is noted that the principles described herein also may apply to any set of signals, which may include text input, sounds actions (e.g., audio tones), video streams (e.g., in ambient computing scenarios), and other potential forms of informational input. In different embodiments, the action recognition module 140 may use various machine learning models for determining an action that can be associated with the user input. For ease of description, the system will be described in the context of supervised machine learning. However, it is noted that the principles described herein also may apply to semi-supervised and unsupervised systems.

In one example embodiment, the action recognition module 140 may directly extract one or more words included in the processed user input for identifying the action, for example, “schedule,” “order,” “invite,” etc. In some embodiments, the action recognition module 140 uses text classification to identify an action that is most likely to correspond to the user input. In this example embodiment, an action model may be trained using labeled examples of input strings. For example, the computing system 130 may store labeled example input strings. The labels associate each example input string with one of the actions. The training data may include example input strings in the form of words, partial sentences, partial phrases, complete sentences, and complete phrases. The action model may also be trained to use the various natural language processing signals produced by the input processing module 135 and the training data may additionally include natural language processing signals.

In some embodiments, the action recognition module 140 may identify an action based on user history (e.g., previous user actions). For example, a user speaks “add . . . ” in a voice command via the client device 110, the corresponding action may be “add a meeting schedule to the calendar,” or “add a product in a shopping list in the reminder, etc.” The action recognition module 140 may access data associated with the user's usage history and find that the user frequently uses the “calendar” function to schedule meetings but seldomly uses the “reminder” function to keep a shopping list. In this case, the action recognition module 140 may identify “add a meeting schedule to the calendar” as the action corresponding to the user input.

The computing system 130 includes a command category module 145, which provides a set of command categories associated with the identified action. Each of the command categories may represent a characteristic of the identified action. For example, an identified action may be “scheduling an appointment,” and the associated command categories may include action parameters, such as, “title” (e.g., what appointment is about), “who” (e.g., the attendees in the appointment), “when” (e.g., the time to be schedule), “where” (e.g., the location of the appointment), etc. In another example, the identified action may be “ordering a pizza,” and the associated command categories may include action parameters, such as, “size,” “toppings,” “sauce,” “restaurant,” “when” (e.g., delivery time or ordering time), “drinks,” etc. In some embodiments, the set of command categories may include required command categories and optional command categories. The required command categories may correspond to action parameters required to perform the action, and the optional command categories may correspond to action parameters related to user preferences, recommendations, etc. Take the action of “ordering a pizza” as an example, the action parameter “toppings” is likely to be a required command category for ordering a pizza, whereas the action parameter “drinks” may be optional. In some embodiments, whether a command category is required or optional may be determined based on user preference, usage history, user statistics, recommendations, etc.

In various embodiments, the command category module 145 accepts the processed user input (e.g., the associated NLP signals) from the input processing module 135, and the identified action from the action recognition module 140 as input. The command category module 145 may also access the action module store 155 and the education model store 160 to use the interface associated with the identified action as an input, thus obtaining the set of command categories that will be needed for the computing system 130 to perform the action. In some embodiments, one or more associated command categories may be extracted from the set of words identified from the processed user input. The extracted words may be associated with one or more pre-defined command categories. For instance, the user may request to “order a pepperoni pizza.” In this case, the action parameter “toppings” is provided and identified from the user input and determined as the command category.

In some embodiments, the command category module 145 uses an action model to provide a set of command categories that are associated with the identified action. In an example embodiment, the action model may be trained using labeled examples of command categories. The labels associate each example command category with one of the actions. The action model may output a set of command categories that are most likely to be associated with an identified action. In some embodiments, the command category module 145 may identify the command categories for a given action based on user history, such as previous user actions. In particular, one or more optional command categories may be included or removed from the set of command categories associated with an action. For example, assuming a user seldomly orders drinks with pizza, the command category module 145 may determine that the set of command categories associated with “ordering a pizza” action does not include an action parameter “drinks” as a command category for this user. Similarly, the user may often order pizza with extra cheese, and the command category module 145 may add the action parameter “cheese options” in the set of command categories associated with “ordering a pizza” action.

In some embodiments, the command category module 145 accesses the set of command categories associated with the identified action from hierarchically structured metadata maintained by a third party system 180. The command category module 145 may access the hierarchically structured metadata from the entity data module 165, which may access the hierarchically structured metadata from the third party system 180 and/or the entity data store 170, as described further below. The hierarchically structured metadata may include a plurality of command categories, where each command category represents characteristics of actions performable via an application of the third party system 180. The command categories may be arranged as nodes of a hierarchy in the hierarchically structured metadata such that one or more command categories may descend from one or more other command categories in the hierarchically structured metadata. For example, in an apparel-related third party system 180, a top-level node may correspond to a general command category (e.g., “product type”), one or more intermediate nodes may correspond to more specific command categories (e.g., “dress,” “shoes,” “pants” under “product type”), and one or more further nodes may correspond to command categories further descending from the intermediate nodes (e.g., “size,” “length,” and “formality” under “dress”). In some embodiments, a command category corresponding to a node of the hierarchically structured metadata may be represented as a key of a key-value pair, where the value is determined based on the user input associated with the command category. In some embodiments, the user input may be a selection of a value from one or more values associated with the command category in the hierarchically structured metadata. The values may be specific to the command category (e.g., values “small,” “medium, “large” for the command category “size”) or may be indicative of command categories (or their respective associated values) that descend from the command category in the hierarchically structured metadata. In some embodiments, a path traversed through the hierarchically structured metadata from a root node to a leaf node may thus be represented as a chain of one or more key-value pairs, where each key-value pair in the chain corresponds to a command category resolved along the path.

In response to receiving the identified action from the action recognition module 140, the command category module 145 parses the hierarchically structured metadata to select one or more command categories corresponding to the identified action. In some embodiments, the command category module 145 parses the hierarchically structured metadata by applying a machine-learned model (e.g., a large language model or other generative language model) that receives the identified action, the first user input, and at least a portion of the hierarchically structured metadata as input, and outputs the one or more command categories. In some embodiments, the output also includes a path of command categories, including the one or more command categories, through the hierarchically structured metadata. In some embodiments, the command category module 145 parses the hierarchically structured metadata by traversing the hierarchically structured metadata programmatically (e.g., by walking from a root node to one or more nodes that match a keyword derived from the identified action or the first user input). In some embodiments, the command category module 145 parses the hierarchically structured metadata by a combination of one or more of the foregoing techniques.

In some embodiments, in response to a user input corresponding to a selected command category, the command category module 145 extracts, from the hierarchically structured metadata, one or more further command categories that descend from the selected command category in the hierarchically structured metadata. For example, in response to a user input selecting the command category of “dress,” the command category module 145 may extract further command categories of “size,” “length,” and “formality” that descend from “dress” in the hierarchically structured metadata. The command category module 145 provides the one or more further command categories to the user education module 150 so that the displayed interface may be updated to include the further command categories.

In some embodiments, in response to one or more subsequent user inputs corresponding to one or more of the further command categories, the command category module 145 selects a subset of the further command categories that descend from each of the selected command categories in the hierarchically structured metadata. The command category module 145 provides the subset to the user education module 150 so that the displayed interface may be updated to remove further command categories that are not in the selected subset. In this way, the command category module 145 progressively narrows the set of further command categories presented to the user based on the additional command categories selected by the user and the hierarchically structured metadata of the third party system 180.

The computing system 130 includes a user education module 150. The user education module 150 may generate an interface for display on the client device 110. The displayed interface may include the user input and a set of placeholder text identifying each of the command categories associated with the identified action. The interface may be displayed to the user as a response to the user input, presenting the received user input and the identified action to the user for review. The set of placeholder text corresponding to the command categories provides a guidance to the user on the characteristics of the identified action so that the user learns whether/what additional user input is needed to perform the action. For example, a user orders a pepperoni pizza, but does not specify a size of the pizza in the voice command. The user education module 150 may generate an interface presenting the user's order with a placeholder text identifying the action parameter of “size” so that the user notices the missing information and inputs the size of pizza in the subsequent input. In some embodiments, the placeholder text may be a generic name of an action parameter, such as, “toppings,” “time,” “size,” etc. Alternatively, the placeholder text may be suggestive text corresponding to the command category, such as, “pepperoni,” “8 pm,” “10 inches,” etc. For ease of discussion, the placeholder text is described in the context of words. However, it is noted that the principles described herein also may apply to any user guidance, which may include images, logos, URLs, and other potential forms of informational output.

In some embodiments, the user education module 150 may present one or more sets of placeholder text including suggestive text in the interface. In one example, for the command category of “toppings,” the user education module 150 may include suggestive text, such as, “pepperoni,” “mushroom,” “spinach,” as the placeholder text displaced to the user. In some embodiments, suggestive text for one or more command categories may be displayed in a separate interface portion for selected by a user. In some embodiments, one or more command categories are required for performing the identified action, and some command categories are optional. Similarly, in some embodiments, some placeholder text is required, and some other placeholder text is optional; and in some other embodiments, one or more placeholder text may be selected for the same command category.

Based on the guidance from the displayed interface, the user may add, remove, modify, and/or select any of the placeholder text for each of the corresponding command categories so that the user may refine and customize the identified action for performance.

The user education module 150 may extract words from the processed user input as the corresponding placeholder text. For example, the user education module 150 may use “pepperoni” from the user input “order a pepperoni pizza” as the placeholder text corresponding to the command category of “toppings.” In some embodiments, the user education module 150 may apply a machine learned model to extract a set of words from the processed user input and to associate the extracted words with the command categories.

The user education module 150 may also access the education model store 160 to obtain a set of placeholder text that corresponds to the identified action and the set of command categories. In one implementation, the user education module 150 may select the corresponding placeholder text based on user history (e.g., previous user actions). For instance, the user often orders a 10-inch pizza, and the user education module 150 may select “10-inch” as the placeholder text corresponding to the command category of “size” and present it in the interface for the user to review. In some embodiments, the user education module 150 may apply a machine-learned model to determine placeholder text that is most likely to inform a user about what to say to provide information required for the command category. For instance, the machine-learned model may determine that including the placeholder text “size” in the “pizza size” command category is the most likely placeholder text to get a user to speak a pizza size, whereas in other embodiments, the placeholder text “12 inches” is the most likely placeholder text to get a user to speak a pizza size.

In some embodiments, the user education module 150 generates the set of placeholder text corresponding to a command category associated with a user input. The user education module 150 may determine a key-value pair based on the command category and the user input, where the key represents the command category and the value represents the user input. In some embodiments, the value may have been presented in the user interface in association with the command category, such that the user could select the value as the user input. In such embodiments, the user education module 150 may retrieve, from the entity data module 165 and/or the entity data store 170, one or more values available for the command category. The values associated with a command category may be associated with the command category itself or with descendent command categories in the hierarchically structured metadata. The user education module 150 may generate the set of placeholder text to include a plurality of selectable text items each corresponding to one of the retrieved values. The user education module 150 may then treat, as the user input, an interaction of the user with one of the selectable text items.. The user education module 150 may generate the set of placeholder text to include a first subset of text specifying the key and a second subset of text specifying the value in the key-value pair. For example, in an apparel-related third party system 180, the user education module 150 may receive a first user input selecting a value of “dress” for the command category of “product type,” where “dress” itself corresponds to a command category having descendant command categories (e.g., “size,” “length,” and “formality”) in the hierarchically structured metadata. The user education module 150 may subsequently receive a second user input selecting a value of “medium” for a further command category (e.g., “size”) that descends from “dress” in the hierarchically structured metadata, the user education module 150 may modify the set of placeholder text to include both “dress” (as the first subset specifying the key) and “medium” (as the second subset specifying the value), for example presented in the displayed interface as “medium dress.” In such embodiments, the key “dress” of the resulting key-value pair is thus associated with a command category (“dress”) that was itself selected as a value in a preceding user input (i.e., as the value for the command category “product type”). In some embodiments, the user education module 150 may generate the set of placeholder text to include only the value. For example, upon receiving a user input specifying a value of “dress” for a command category of “product type,” the user education module 150 may modify the set of placeholder text to include “dress” but not “product type.”

In some embodiments, the user education module 150 applies a machine-learned model (e.g., a large language model or other generative language model) to generate the set of placeholder text corresponding to a command category. The machine-learned model may receive, as inputs, one or more of the identified action, the command category, the first user input, at least a portion of the hierarchically structured metadata, or one or more values available for the command category (e.g., retrieved from the entity data module 165 and/or the entity data store 170), and output the set of placeholder text. In some embodiments, the machine-learned model outputs the set of placeholder text as one or more selectable text items each corresponding to a value available for the command category, or as text that combines a key of a key-value pair with a value of the key-value pair in a natural language form. In some embodiments, the user education module 150 further applies the machine-learned model to modify the set of placeholder text based on a subsequent user input received for the command category. For example, upon receiving the subsequent user input specifying a value for the command category, the machine-learned model may receive, as inputs, the previously generated set of placeholder text and the subsequent user input, and output the modified set of placeholder text.

In some embodiments, as additional user inputs are received for additional command categories, the user education module 150 generates additional key-value pairs corresponding to the additional command categories. The user education module 150 may update the displayed set of placeholder text to include, for each newly resolved additional command category, either a subset of text specifying both the key and the value of the corresponding key-value pair or a subset of text specifying only one of the key or the value, while retaining the previously generated placeholder text for previously resolved command categories. For example, continuing the example above in which the user education module 150 has generated the set of placeholder text to include “product type: dress” based on a user input specifying a value of “dress” for the command category of “product type,” upon receiving a further user input specifying a value of “M” for a command category of “size” that descends from “dress” in the hierarchically structured metadata, the user education module 150 may update the set of placeholder text to include “product type: dress; size: M” (specifying both keys and values for both resolved command categories), or to include “product type: dress; M” (specifying the key and the value for the previously resolved command category and only the value for the newly resolved command category), or to include “medium dress” (specifying only the value for the previously resolved command category and the value for the newly resolved command category). In some embodiments, the user education module 150 applies a machine-learned model (e.g., a large language model or other generative language model) to the resolved key-value pair(s) to generate the modified set of placeholder text in a natural language form. For example, based on the resolved key-value pairs “product type: dress” and “size: M,” the machine-learned model may generate the modified set of placeholder text as “medium dress,” “a medium-sized dress,” or “dress in size medium.” In some embodiments, the machine-learned model receives, in addition to the resolved key-value pair(s), one or more of the identified action, the first user input, the second user input, or at least a portion of the hierarchically structured metadata as inputs to the machine-learned model.

In some embodiments, the user education module 150 may present a chain of the key-value pairs in the displayed interface, wherein each key-value pair in the chain corresponds to a command category resolved by user input. In some embodiments, the chain of key-value pairs is ordered according to a path of command categories traversed through the hierarchically structured metadata of the third party system 180. The chain of key-value pairs may be transmitted to the application of the third party system 180 to cause the application of the third party system 180 to perform the identified action.

In some embodiments, the user education module 150 groups command categories resolved by the user input. For instance, the user education module 150 may determine, for each command category resolved by the user input, whether the command category is related to one or more other command categories resolved by the user input. In some embodiments, the user education module 150 determines that command categories are related based on the hierarchically structured metadata of the third party system 180. For example, the user education module 150 may determine that two or more command categories are related in response to determining that the command categories descend from a common node of the hierarchically structured metadata, occupy a common branch of the hierarchically structured metadata, or describe a common item represented in the hierarchically structured metadata. In some embodiments, the user education module 150 determines that two or more command categories are related using a machine-learned model (e.g., a large language model or other generative language model) configured to group command categories by similarity, applying natural language processing techniques to identify command categories corresponding to related terms, or detecting co-occurrence of the command categories (or associated values) from historical resolutions of user inputs.

In some embodiments, the user education module 150 groups the related command categories in the displayed interface by presenting the corresponding placeholder text as a single, visually distinct interface element (e.g., a consolidated set of placeholder text). In some embodiments, the entity data module 165 groups the related command categories in the set of structured parameters transmitted to the application of the third party system 180 by nesting the corresponding key-value pair(s) under a common group. In some embodiments, the computing system 130 groups the related command categories in both the displayed interface and the set of structured parameters. The user education module 150 may update the grouping in real-time as additional command categories are resolved from subsequent user input, adding a resolved command category to an existing group or forming a new group.

In some embodiments, the user education module 150 groups the resolved command categories into a plurality of groups, assigning command categories that describe a common item to a common group and command categories that describe different items to different groups. For example, from a user input of “order 1 large pepperoni thin crust pizza,” the user education module 150 may group the placeholder text for “large,” “pepperoni,” and “pizza” as “large pepperoni pizza” describing a first item, along with a separate group for “thin crust.” The user education module 150 may additionally or alternatively group command categories that descend from a common node of the hierarchically structured metadata, or form a single group of the resolved command categories. The grouping may be applied to command categories resolved from any form of user input.

The action model store 155 stores program code for computer models that are trained and applied by the action recognition module 140 to identify an action that is most likely to be relevant to a given user input string. In some embodiments, the labeled training data and records of previously matched actions and user inputs may be stored at the action model store 155. The action model store 155 can also store a list of available actions, that is, tasks that the computing system 130 can perform for the user in response to a user input. The action model store 155 also stores the set of command categories associated with each action. The action model store 155 may store program code for computer models that are trained and applied by the action recognition module 140 to obtain the command categories associated with each action. The computer models may be trained with a training dataset that includes commands and actions received from other users. Further, the action model store 155 can store custom actions built and trained by users that are only available for those users.

The education model store 160 stores the models and training data applied by the user education module 150. The education model store 160 also may include the placeholder text based on user preference, user history, user statistics, recommendations, etc. In some embodiments, the education model store 160 stores program code for a user interface for each of the actions that can be performed by the computing system 130. An interface stored by the education model store 160 may include layouts for displaying the interface on a client device 110. In various embodiments, the user interfaces may be interfaces that have been custom made for each potential action. In other embodiments the education model store 160 can contain custom interfaces for custom actions designed by users, and only for use by those users.

The computing system 130 includes an entity data module 165. The entity data module 165 accesses structured data associated with a third party system 180 (also referred to as an entity), and provides the accessed structured data to one or more of the command category module 145, the user education module 150, or the entity data store 170. The structured data associated with the third party system 180 may include the hierarchically structured metadata described above, as well as one or more value(s), attribute(s), or descriptive metadata (e.g., images, prices, inventory indicators, availability, or brand information) associated with individual command categories in the hierarchically structured metadata.

The entity data module 165 may access the structured data associated with the third party system 180 through one or more mechanisms. In some embodiments, the entity data module 165 accesses the structured data directly from a schema or data dictionary provided by the third party system 180, wherein the schema identifies the command categories representing characteristics of actions performable via the application of the third party system 180. In some embodiments, the entity data module 165 accesses the structured data from a database maintained by, or synchronized with, the third party system 180 (e.g., a synchronized product catalog, inventory database, or configuration database). In some embodiments, the entity data module 165 accesses the structured data through a real-time injection mechanism in which one or more values of the structured data are provided by the third party system 180 in response to a request from the entity data module 165 (e.g., in response to determining that the structured data available to the entity data module 165 does not include a value for a particular command category).

In some embodiments, the entity data module 165 obtains the structured data associated with the third party system 180 using a data crawler. The data crawler may be implemented as a browser-side component (e.g., a browser extension executing within a web browser on the client device 110) that observes a rendered Document Object Model (DOM) of one or more pages associated with the third party system 180 and extracts structured data from the DOM. In other embodiments, the data crawler is implemented as a server-side crawler (e.g., executing on the computing system 130 or another server) that retrieves one or more pages or feeds associated with the third party system 180 (e.g., HTML pages, XML feeds, JSON-LD documents, sitemaps, or product feeds) and extracts structured data from the retrieved pages or feeds. In some embodiments, the entity data module 165 uses one or more machine-learned models to identify and extract structured data from unstructured or semi-structured sources associated with the third party system 180.

In some embodiments, the entity data module 165 selects a subset of the structured data based on the identified action determined by the action recognition module 140, and injects the selected subset into a context of a machine-learned model used by the user education module 150 to generate the set of placeholder text. In this way, the machine-learned model receives, in its context, only the portion of the structured data that is relevant to the identified action, rather than the entire set of structured data associated with the third party system 180.

In some embodiments, the entity data module 165 receives the modified set of placeholder text (or one or more key-value pair(s) determined from the modified set of placeholder text) from the user education module 150, generates a set of structured parameters comprising the key-value pair(s) that map one or more command categories to corresponding value(s) based on the modified set of placeholder text, and transmits the set of structured parameters to the application of the third party system 180 to cause the application of the third party system 180 to perform the identified action. For example, based on a modified set of placeholder text “white dress” corresponding to command categories “product color” and “product type,” the entity data module 165 may generate a set of structured parameters comprising the key-value pairs “product_color: white” and “product_type: dress,” and transmit the set of structured parameters to the application of the third party system 180 to cause the application of the third party system 180 to execute a corresponding product search.

In some embodiments, the third party system 180 is the client device 110 itself, or an operating system or other software executing on the client device 110. For example, in some embodiments, the client device 110 is a smartphone (e.g., a smartphone running a mobile operating system) and the third party system 180 is the operating system of the smartphone. In some such embodiments, the structured data associated with the third party system 180 may comprise a settings schema of the operating system, in which each command category corresponds to an individual setting of the operating system (e.g., “Wi-Fi network,” “screen brightness,” “notification preferences,” “default messaging app”), and the identified action comprises modifying one or more of the settings. In some embodiments, the third party system 180 may be a desktop operating system, an in-vehicle infotainment system, a smart home hub, a wearable device, or any other device or device-resident software whose configuration or behavior is described by a corresponding schema.

The entity data store 170 stores structured data associated with the third party system 180. In some embodiments, the entity data store 170 stores the hierarchically structured metadata (e.g., a schema, a taxonomy, or a data dictionary) obtained from or synchronized with the third party system 180. In some embodiments, the entity data store 170 also stores one or more values, images, prices, inventory indicators, availability indicators, brand information, or other descriptive metadata associated with individual command categories in the hierarchically structured metadata. In some embodiments, the entity data store 170 stores program code for machine-learned models that are trained and applied by the entity data module 165 to extract structured data from unstructured or semi-structured sources associated with the third party system 180. In various embodiments, the entity data store 170 may be implemented as a relational database, a document store, a key-value store, a graph database, or any other data storage system.

The third party system 180 is a computing system external to the computing system 130 and communicatively coupled to the computing system 130 via the network 120. The third party system 180 may correspond to an entity (e.g., a merchant, a service provider, an enterprise, an application developer, or a device manufacturer) that maintains structured data related to actions performable via an application of the third party system 180. In some embodiments, the third party system 180 provides one or more of a schema, a synchronized database, or a real-time injection endpoint from which the entity data module 165 accesses the structured data. The third party system 180 receives, from the computing system 130, one or more structured parameters generated based on the modified set of placeholder text, and performs the identified action based on the received structured parameters.

Although the examples described herein primarily describe the first user input as a voice command or a typed text input, the first user input and any subsequent user input(s) received by the computing system 130 may take any of a variety of forms, including a voice command, a typed text input, an image, or a gesture input (e.g., a gesture received from an augmented-reality device). The client device 110 may correspondingly be any of a variety of devices, including a smartphone, a tablet, a laptop or desktop computer, a wearable device, a smart speaker, an augmented-reality device, or a set-top box.

### Computing System Example

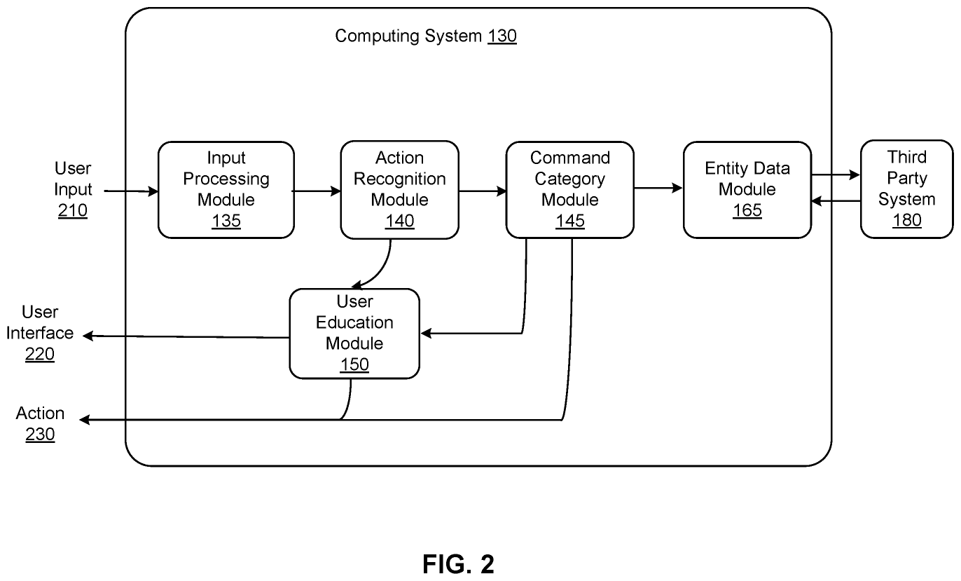

FIG. 2 is a diagram of the interactions between components of the computing system 130, in accordance with an example embodiment. The computing system 130 receives a user input 210. The user input may be a complete sentence or concept, or a partial sentence or phrase, expressed by a user, for example, in the form of typed text or spoken audio. The computing system 130 may begin to respond to a user by displaying an interface as the user is still providing input. In some cases, therefore, the user input 210 received by the computing system 130 may be only a first part of the user input, e.g., a word or set of words.

The user input 210 is provided to the input processing module 135, which analyzes the user input 210 and outputs corresponding processed signals, such as NLP signals. The processed signals and the user input 210 are provided to the action recognition module 140. The action recognition module 140 predicts an action that the user intends to perform. The predicted action, processed signals, and user input are provided to the command category module 145, which generates a set of command categories associated with the identified action. In some embodiments, the command category module 145 provides the identified action to the entity data module 165, which accesses structured data associated with a third party system 180 (e.g., hierarchically structured metadata identifying command categories corresponding to the identified action) and provides the accessed structured data back to the command category module 145 and/or the user education module 150. The identified action, processed signals, user input, and the set of command categories may be also provided to the user education module 150 to enable the display (on a screen of a computing device, e.g., client device) of a user interface 220. The displayed interface may include the user input and a set of placeholder text identifying each of the command categories associated with the identified action. Upon reviewing the displayed user interface 220, the user may enter subsequent user input to the computing system 130 to modify and/or refine the action and the associated command categories. The computing system 130 may use one or more of the input processing module 135, action recognition module 140, command category module 145, entity data module 165, and user education module 150 to further process the subsequent user input. In one example, the subsequent user input may change the identified action, and consequently, the corresponding command categories and placeholder text may also be changed. In another example, the subsequent user input may add, remove, modify, and/or select any of the placeholder text for the corresponding command categories. In another example, the subsequent user input may confirm the identified action and the placeholder text, and the computing system 130 may determine the action is finalized and proceed to perform the action 230 (e.g., by transmitting a set of structured parameters generated by the entity data module 165 to an application of the third party system 180). In this way, the user interface 220 to be generated and enabled (or provided) for display on the client device can advantageously begin to change in substantially real-time and provide real-time guidance to the user.

In some embodiments, the components of the computing system 130 may be configured to interact in ways other than that showed in the example of FIG. 2. In one embodiment, the computing system 130 may be configured to include a feedback loop among the action recognition module 140, the command category module 145, and the user education module 150. In other example embodiments, one module may be configured to perform the functions of both the action recognition module 140, the command category module 145 and the user education module 150. In another example embodiment, the computing system may not include an input processing module 135. In such embodiments, the action recognition module 140, the command category module 145, and the user education module 150 may be trained to identify an action and command categories and generate placeholder text based directly on a user input 210.

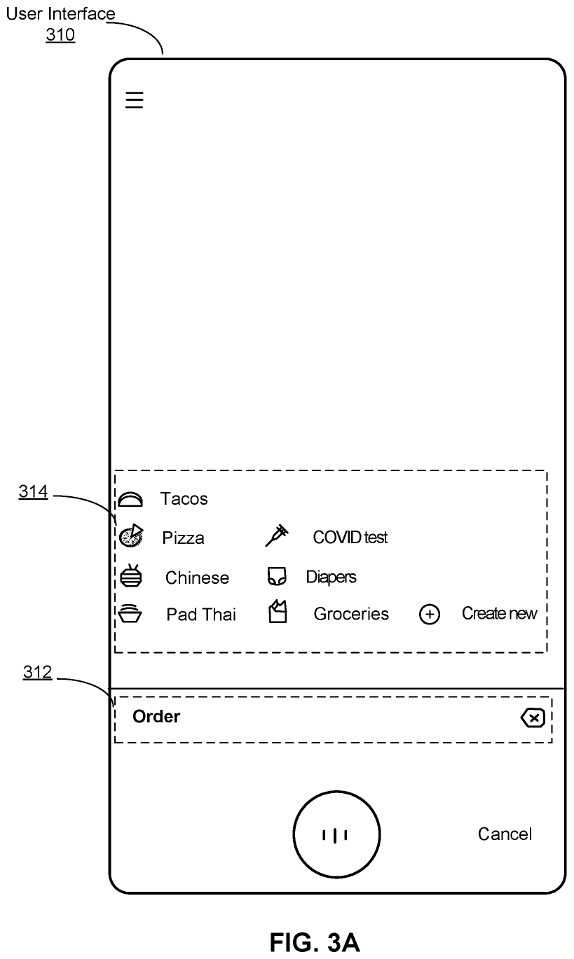

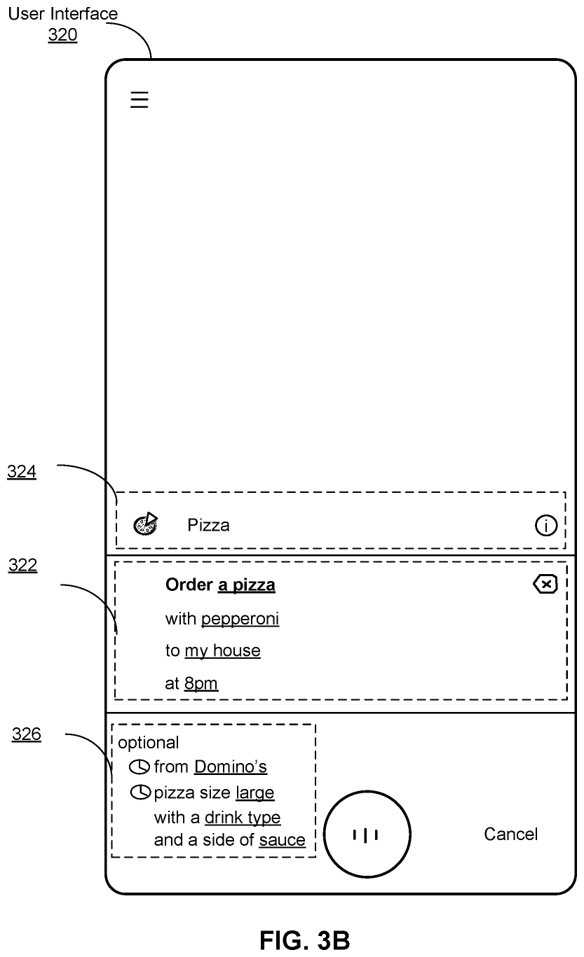

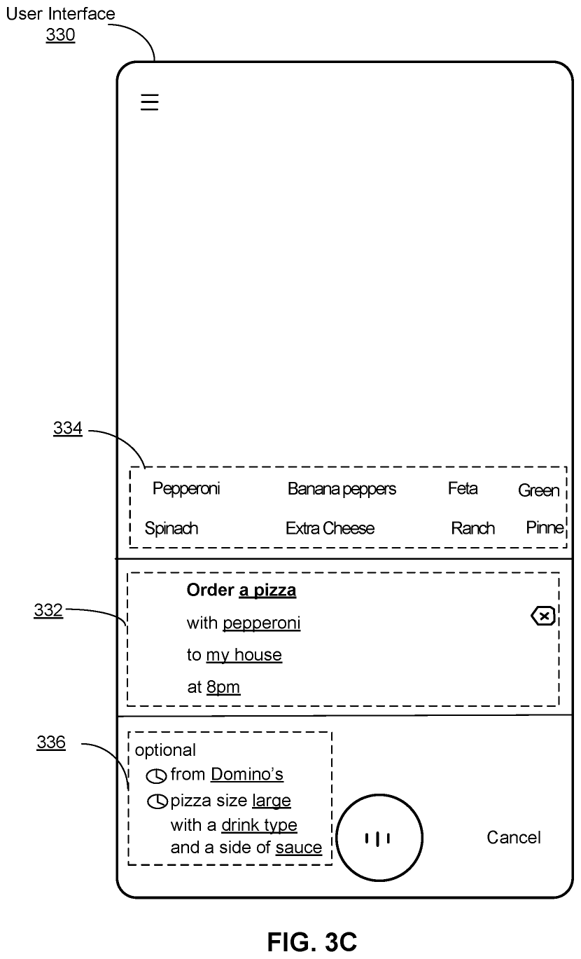

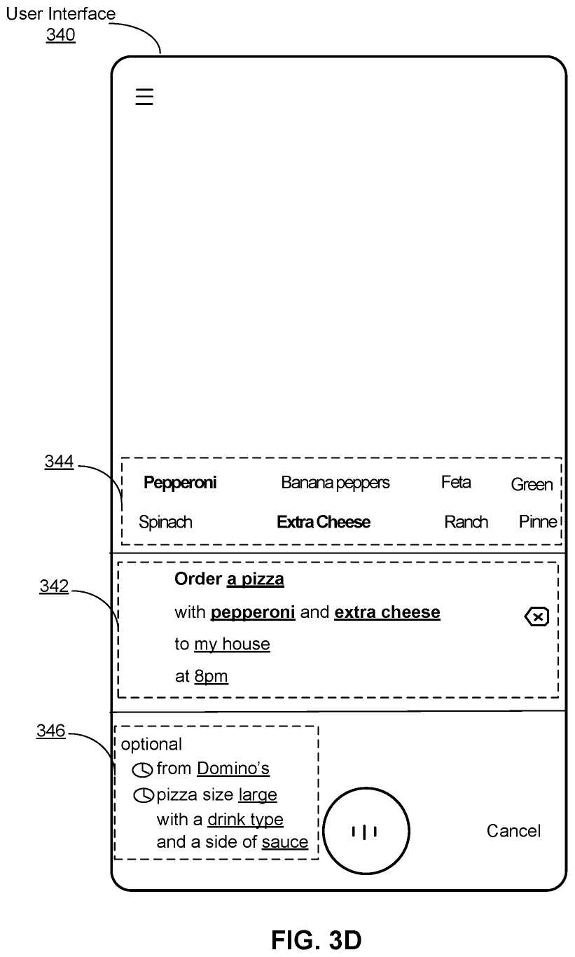

The following FIGS. 3A through 3D illustrate an example of an interface of a digital interface generating user guidance as user input is received, in accordance with an embodiment. In one embodiment the interface is a user interface presented for display on a screen of a computing device, e.g., a client device 110 such as a smartphone, tablet, wearable device, standalone display, laptop or desktop computer. FIGS. 3A through 3D show an example in which the user input received, e.g., via the client device 110, has been identified as an action (i.e., function or user request) of ordering a pizza. The layouts of the displayed interface change as additional placeholder text corresponding to the command categories associated with the selected interface are determined in response to the receipt of additional user input.

FIG. 3A illustrates a first layout displayed for an interface 310 associated with an “order” action, in accordance with an example embodiment. In the example of FIG. 3A, the computing system 130 receives an initial user input that includes the word “order.” In some embodiments, the user input may be a voice command, and the computing system 130 processes the voice command and determines an NLP signal that includes the word “order.” The computing system 130 determines that the user input is most likely associated with an ordering action. The computing system 130 generates an interface 310 comprising the user input in an interface element 312. In some embodiments, the interface is displayed approximately instantaneously to the user. The interface 310 may include suggestive text in another interface element 314 associated with the user input and the identified action. The suggestive text may be used as guidance and/or recommendation for the user to determine the subsequent user input. In the example of FIG. 3A, the interface 310 includes action items for the identified action, i.e., what to order. As shown in FIG. 3A, the displayed suggestive text includes potential command categories corresponding to “order”, e.g., tacos, pizza, diapers, etc.. The computing system 130 uses the interface 310 to guide the user for subsequent inputs to refine/modify/specify the action to be performed. The user may select any of the suggestive text, create new action item, continue input additional information, or cancel the action.

FIG. 3B illustrates a second layout displayed for an interface 320 associated with a pizza-ordering action, in accordance with an example embodiment. In FIG. 3B, the user input includes additional information. In particular, the user has added additional input so that the user input now includes, “Order a pizza”. The computing system 130 determines that the selected action is to order a pizza, identifies a set of command categories associated with the action and determines placeholder text corresponding to the command categories. Accordingly, the user interface 310 changes from the layout of FIG. 3A to the layout 320 shown in FIG. 3B. The interface 320 may include an interface element 322 comprising the user input and the placeholder text corresponding to the command categories. For example, the interface element 322 in FIG. 3B includes the user input “order a pizza” and suggestive placeholder text, such as “pepperoni” for the “toppings” command category, “my house” for the “delivery location” command category, and “8 pm” for the “time of delivery” command category. In practice, the interface element 322 can include non-suggestive placeholder text, such as text that identifies the action parameters associated with the “order a pizza” action, for instance “with [toppings]”, “to [delivery location]”, and “at [delivery time]”.

In one implementation, each placeholder text corresponding to each command category may be presented in a separate line, which beneficially allows a user to jump between command categories, to delete a command category, to edit a command category, and the like. In another implementation, the identified action and/or placeholder text that are confirmed by the user may be highlighted in different font, color, bold, etc. In still another implementation, the placeholder text and/or the identified action may be underlined so as to notify the user that the corresponding text is modifiable. In some embodiments, the interface 320 may include an interface element 324 to highlight the identified action to be performed. In some embodiments, the interface 320 may also include another interface element 326 for presenting placeholder text corresponding the optional command categories. For example, the computing system 130 may determine that the optional command categories associated with the pizza-ordering action include action parameters, such as, “restaurant,” “size,” “drink,” and “sauce,” etc. Accordingly, the interface 320 presents the suggestive placeholder text, e.g., “Domino's,” “large,” and action parameters, e.g., “drink type,” and “sauce” with the interface element 326. In this way, the interface 320 provides a guidance to the user for subsequent user input to refine/modify/specify the action to be performed. In some embodiments, the computing system 130 may determine the placeholder text using a machine learned model to predict text that is most likely to be input by the user. In some embodiments, the computing system 130 may determine the placeholder text based on user preference, user history (e.g., previous user actions), user statistics, recommendations, etc.

FIG. 3C illustrates a third layout displayed for an interface 330 associated with a pizza-ordering action, in accordance with an example embodiment. Upon reviewing the displayed interface, the user may modify one or more of the placeholder texts with subsequent user input. For example, as shown in FIG. 3C, the computing system 130 may detect that the user interacts with the one or more interface elements in the interface 330. Particularly, the user selects suggestive text (e.g., “pepperoni”) that corresponds to the command category of “toppings,” indicating that the user intends to modify the toppings of the to-be-ordered pizza. The computing system 130 may generate a set of suggestive text corresponding to the command category of “toppings,” and the generated suggestive text may be presented in an interface element 334 in the user interface 330. The user may use the suggestive text displayed in the interface element 334 to select, modify, add, and/or remove the placeholder text of the corresponding command category. In addition to displaying suggestive text, the interface element 334 may include a calendar interface for selecting a date, may show a clock interface for selecting a time, may include images to select between (such as images of pizza toppings), or may include any other interface element to provide a guidance for the user.

FIG. 3D illustrates a fourth layout displayed for an interface 340 associated with a pizza-ordering action, in accordance with an example embodiment. In FIG. 3D, the computing system 130 receives additional user input. In particular, the user input has added additional information, i.e., “extra cheese.” The computing system 130 determines the additional user input corresponds to the command category of “toppings.” Accordingly, the user interface changes from the layout 330 shown in FIG. 3C to the layout 340 shown in FIG. 3D. For example, FIG. 3D shows an interface element 342 and an interface element 344 that highlights placeholder text approved/confirmed/selected by the user in bold.

The examples of FIGS. 3A to 3D beneficially reflect changing user interfaces that change via a substantially (or almost) simultaneous refresh as a received user input is gradually augmented with additional information. The digital interface described herein guides a user of what to say in real-time, with a continuously reinforcing framework (loop) of education and feedback techniques. Th digital interface recognizes and understands the user input (e.g., text input, voice command, etc.), and provides an interface for guiding the user on the subsequent input. In this way, the digital interface receives an entire set of instructions from the user before performing the action required by the user so that the digital interface does not perform an inapplicable task for the user, resulting in i) fewer back and forth clarifying questions, and ultimately ii) a higher success rate.

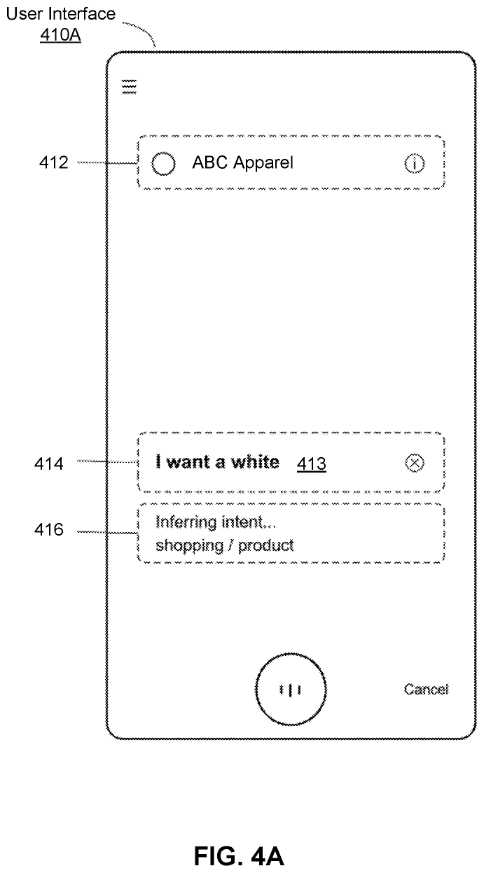

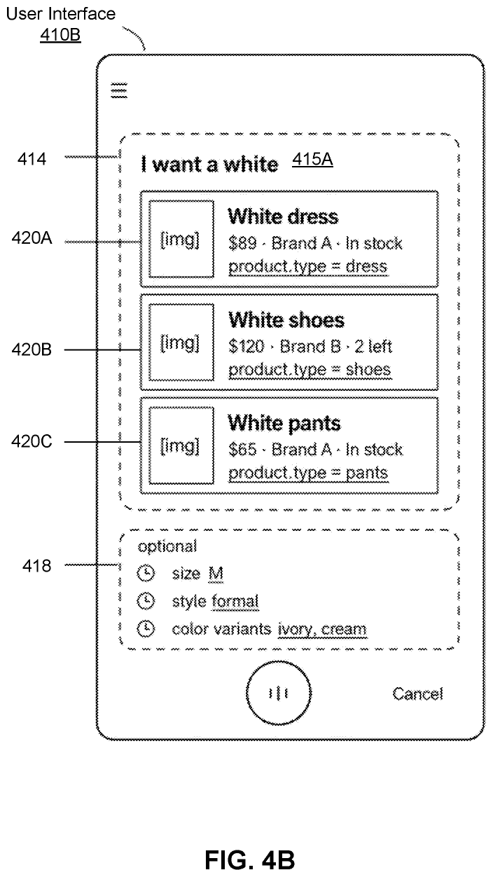

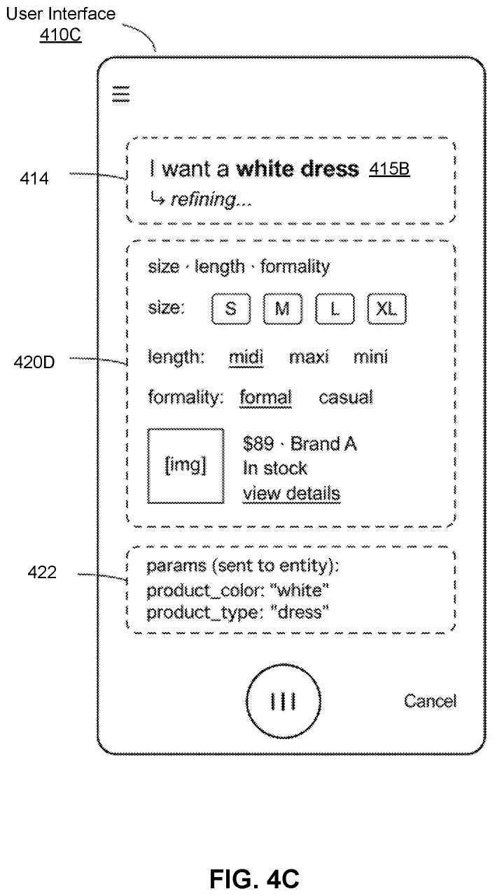

FIG. 4A illustrates a first layout displayed for an interface 410A associated with a third party system 180, in accordance with an example embodiment. In the example of FIG. 4A, the computing system 130 receives an initial user input 413 that includes a phrase such as “I want a white. The user education module 150 generates the interface 410A comprising a search field 414 that includes the user input 415A and text 416 indicating a state of the digital interface with respect to the user input 415A (e.g., a text indicator such as “refining . . . ” signaling that the computing system 130 is processing the user input 413 to identify one or more command categories).

The command category module 145 accesses hierarchically structured metadata associated with the third party system 180 from the entity data module 165 and identifies one or more command categories corresponding to an action implied by the initial user input 413 (e.g., buying a dress). Based on the identified command categories, the user education module 150 generates updates the interface 410A to include a set of placeholder text 415A in the search field 414. The set of placeholder text 415A corresponds to the identified command categories (e.g., the value of “white” for the command category “product color”). In some embodiments, such as the embodiment shown in FIG. 4B, the set of placeholder text may be the same as the text of the user input.

FIG. 4B illustrates a second layout displayed for an interface 410B associated with the third party system 180, in accordance with an example embodiment. In FIG. 4B, the user input 415B has been augmented with additional information (e.g., “I want a white”), shown in the search field 414. In response to the augmented user input 415B, the command category module 145 identifies a set of command categories (e.g., “product type” with candidate values of “dress,” “shoes,” and “pants”) from the hierarchically structured metadata, and the user education module 150 generates the interface elements 420A, 420B, and 420C to include three different sets of placeholder text (e.g., “white dress,” “white shoes,” and “white pants”). Each set of placeholder text combines a value (e.g., “white”) resolved from the user input 413 for a command category (e.g., “product color”) with a corresponding candidate value (e.g., “dress,” “shoes,” or “pants”) for the further command category (e.g., “product type”). In some embodiments, the placeholder text does not include the resolved value and only includes a candidate value and may be included in the search field 414 itself. Each of the interface elements 420A, 420B, and 420C may further include one or more of an image retrieved from the structured data (e.g., a product image), descriptive metadata retrieved from the structured data (characteristics such as a price, a brand, or an availability indicator), or an indication of the further command category and its candidate value (e.g., “product. type =dress”). The interface 410B may further include an optional element 418 that presents additional command categories that the user may use to further refine the action (e.g., size, style, or color variants) and selectable values for the additional command categories retrieved from the structured data.

FIG. 4C illustrates a third layout displayed for an interface 410C associated with the third party system 180, in accordance with an example embodiment. In FIG. 4C, the computing system 130 has received a second user input corresponding to interface element 420A, which was associated with selectable placeholder text (e.g., “white dress”). Accordingly, the user education module 150 modifies the set of placeholder text 415A in the search field 414 to include the new portions of the selected set of placeholder text (e.g., “dress”) from the interface element 420A, reflecting the resolved values for the command category of ““product type.” The command category module 145 traverses the hierarchically structured metadata to identify one or more further command categories (e.g., “size,” “length,” and “formality”) that descend from the “dress” node of the hierarchically structured metadata, and the user education module 150 generates a further interface element 420D including selectable placeholder texts corresponding to values of the further command categories (e.g., size values of “S,” “M,” “L,” and “XL”; length values of “midi,” “maxi,” and “mini”; and formality values of “formal” and “casual”). In some embodiments, each set of placeholder text in the interface element 420D may be selectable by the user to further narrow the search. The interface element 420D may additionally include a specific matching product retrieved from the structured data (e.g., presented with an image, a price, a brand, and an availability indicator).

The interface 410C further includes a parameters element 422 that displays a representation of a set of structured parameters generated by the user education module 150 and/or the entity data module 165 based on the modified set of placeholder text. In the example of FIG. 4C, the parameters element 422 displays the set of structured parameters as a chain of key-value pair(s), each key-value pair mapping a command category resolved by user input to a corresponding value based on the modified set of placeholder text for the command category (e.g., “product_color: white” and “product_type: dress”). In some embodiments, the chain of key-value pairs is ordered according to a path of command categories traversed through the hierarchically structured metadata. In some embodiments, upon receiving one or more further selections of sets of placeholder text from interface element 420D, the user education module 150 generates additional key-value pair(s) for the further command categories and appends the additional key-value pair(s) to the chain in the parameters element 422. The chain of key-value pair(s) may be transmitted, by the entity data module 165, to an application of the third party system 180 to cause the application of the third party system 180 to perform the identified action based on the chain of key-value pair(s).

In some embodiments, in response to receiving one or more subsequent user inputs corresponding to one or more of the further command categories (e.g., a selection of “M” from the size values of the interface element 420D), the command category module 145 selects a subset of the further command categories that descend from each of the selected command categories in the hierarchically structured metadata, and the user education module 150 updates the interface 410C to remove further command categories that are not in the selected subset. In this way, as additional command categories are resolved by user input, the interface progressively narrows the further command categories presented to the user.

In one implementation, each placeholder text corresponding to each command category may be presented in a separate line. In another implementation, the identified action and/or placeholder text that are input/accepted/selected by the user may be highlighted in different font, color, bold, etc. In still another implementation, the placeholder text and/or the identified action may be underlined so as to notify the user that the corresponding text is modifiable. The interface may include an interface element to highlight the identified action to be performed. The interface may also include another interface element for presenting placeholder text corresponding the optional command categories. For example, the interface may include more than one set of placeholder text for some command categories as recommendations to the user.

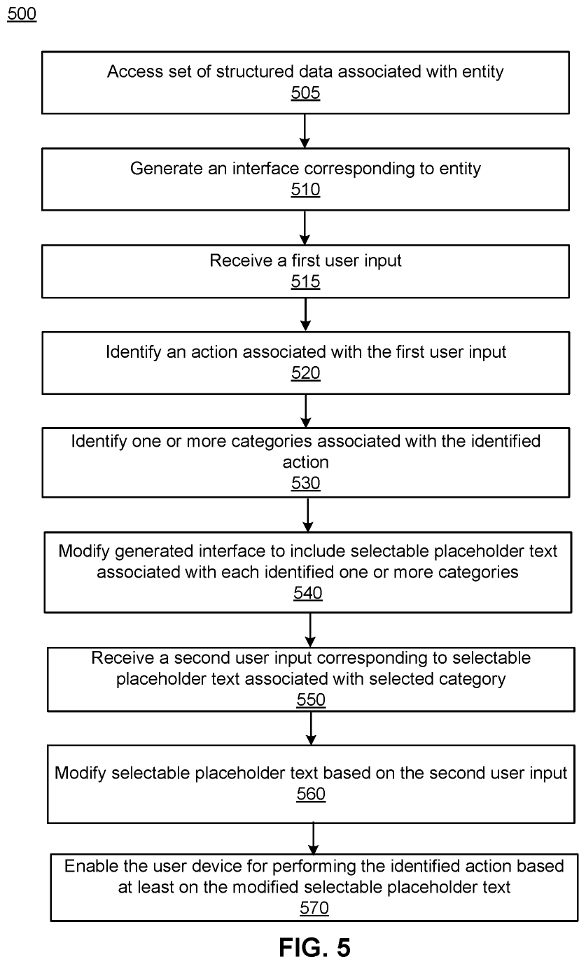

FIG. 5 is a flowchart illustrating an example process 500 of using a digital interface with user input guidance based on structured data, in accordance with an example embodiment. The computing system 130 receives 510 a first user input from a client device 110. The computing system 130 identifies 520 an action associated with the first user input. The computing system 130 accesses 530 a command category associated with the identified action, the command category representing a characteristic of the identified action. The computing system 130 generates 540 an interface for display on the client device 110 to include the first user input and a set of placeholder text identifying the command category. The computing system 130 receives 550, from the client device 110, a second user input corresponding to the command category. The computing system 130 modifies 560 the set of placeholder text corresponding to the command category based on the second user input. The computing system 130 enables 570 the client device 110 for performing the identified action based at least on the modified set of placeholder text.

In some embodiments, identifying 520 the action associated with the first user input comprises performing a natural language processing operation on the received first user input by the input processing module 135, and generating 540 the interface comprises identifying the command category corresponding to the processed first user input and determining placeholder text corresponding to the identified command category based on the processed first user input.

In some embodiments, generating 540 the interface comprises applying a machine-learned model to the identified command category and the first user input, the machine-learned model configured to select a plurality of sets of text, each set of text in the plurality associated with at least a threshold likelihood of being input by the user as the second user input; receiving, from the machine-learned model, the plurality of sets of text; generating the interface to include the plurality of sets of text, wherein the interface is configured to receive interactions with each set of text in the plurality; and, in response to receiving an indication of an interaction with a first set of text of the plurality, selecting the first set of text as the second user input.

In some embodiments, accessing 530 the command category associated with the identified action comprises inputting the identified action and a set of user metadata of a user associated with the client device 110 to a machine-learned model, wherein the machine-learned model is configured to determine the command category based on previous user actions.

In some embodiments, modifying 560 the set of placeholder text corresponding to the command category based on the second user input comprises replacing, in the displayed interface, at least a subset of the set of placeholder text with text corresponding to the second user input.

In some embodiments, accessing 530 the command category associated with the identified action comprises accessing hierarchically structured metadata from a third party system 180, wherein the hierarchically structured metadata includes a plurality of command categories representing characteristics of actions, and parsing the hierarchically structured metadata to select the command category based on the identified action.

In some embodiments, enabling 570 the client device 110 for performing the identified action based at least on the modified set of placeholder text comprises extracting, from the hierarchically structured metadata, one or more further command categories that descend from the command category in the hierarchically structured metadata, and updating the displayed interface to include one or more of the further command categories. In some embodiments, enabling 570 the client device 110 for performing the identified action comprises updating the displayed interface to include an interface element, in response to receiving an interaction, transmits data describing the command categories to the third-party system, such that the third-party system 180 performs the identified action based on structured parameters associated with the data.

In some embodiments, the computing system 130 further receives, from the client device 110, a third user input corresponding to a second command category of the further command categories, and further modifies the set of placeholder text based on the third user input, wherein a first subset of the modified set of placeholder text corresponds to the command category and a second subset of the modified set of placeholder text corresponds to the second command category. The computing system 130 selects a subset of the further command categories that descend from the command category and the second command category in the hierarchically structured metadata, and updates the displayed interface to remove further command categories that are not in the selected subset.

In some embodiments, the modified set of placeholder text is associated with a first key-value pair, the first key-value pair comprising the command category as a first key and a value associated with the second user input as a first value. The computing system 130 further updates the displayed interface to include one or more further command categories associated with the command category, the one or more further command categories determined based on a hierarchically structured metadata; receives, from the client device 110, a third user input corresponding to a second command category of the one or more further command categories; and further modifies the set of placeholder text based on the third user input, wherein the further modified set of placeholder text is associated with the first key-value pair and a second key-value pair comprising the second command category as a second key and a value associated with the third user input as a second value. The computing system 130 further updates the displayed interface to include the first key-value pair and the second key-value pair.

In some embodiments, the hierarchically structured metadata is obtained from the third party system 180 by a data crawler implemented by the entity data module 165. For example, the data crawler may be implemented as a browser extension that executes within a web browser on the client device 110 and extracts structured data from a rendered Document Object Model of one or more pages associated with the third party system 180. In some embodiments, the data crawler is a server-side crawler that retrieves one or more pages or feeds associated with the third party system 180 and extracts structured data from the retrieved pages or feeds.

In some embodiments, the third party system 180 comprises the client device 110, and the hierarchically structured metadata comprises a settings schema of an operating system executing on the client device 110. In such embodiments, the identified action comprises modifying one or more settings of the operating system, and the modified set of placeholder text represents a configuration to be applied to the one or more settings of the operating system.

In some embodiments, the first user input received 510 by the computing system 130 comprises one or more of a voice command, a typed text input, an image, or a gesture input received from an augmented-reality device, and any subsequent user input received by the computing system 130 (including the second user input and any further user input) may take a corresponding form.

The steps in the process 500 discussed above can vary across different procedures, including having additional or different steps than those shown, and the steps may occur in different orders. In some embodiments, depending on the user input to the computing system 130, the process 500 may skip, repeat some of the steps, or restart the process from an earlier step.

### Example Computing System

FIG. 6 is a block diagram illustrating components of an example machine able to read instructions from a machine-readable medium and execute them in one or more processors (or controllers), in accordance with an example embodiment. Specifically, FIG. 6 shows a diagrammatic representation of the computing system 130 in the example form of a computer system 600. The computer system 600 can be used to execute instructions 624 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor executes an operating system for the computing system 500. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. For example, the instructions 624 may include instructions for implementing the functionalities of the input processing module 135, the function matching module 140 and/or the command category module 145. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626, such as the network 120, via the network interface device 620. Further, for the client device (or user device), the instructions received may be instructions from a server system that enable functions on the client device. For example, how a user interface is to be displayed may include receiving code for how the user interface should be enabled (e.g., rendered) for display based on how that code appropriately interfaces with the operating system of the client device.

While machine-readable medium 622 is shown in an example embodiment to be a single medium, the term “machine-readable medium” should be taken to include a single medium or multiple media (e.g., a centralized or distributed database, or associated caches and servers) able to store the instructions 624. The term “machine-readable medium” shall also be taken to include any medium that is capable of storing instructions 624 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The digital interface described herein grounds a user's natural-language input in hierarchically structured metadata of a third party system 180, so that the command categories, further command categories, and placeholder text presented to the user correspond to characteristics of actions actually performable via an application of the third party system 180. By extracting further command categories that descend from a selected command category in the hierarchically structured metadata, and by narrowing the presented further command categories to a subset that descends from each of a plurality of resolved command categories, the digital interface progressively narrows a natural language search based on the structured data maintained by the third party system 180, reducing the number of back-and-forth clarifying inputs required to resolve an action. By representing the modified set of placeholder text corresponding to each resolved command category as a key-value pair and presenting a chain of the key-value pair(s) in the interface, the digital interface produces structured parameter(s) that are directly actionable by an application of the third party system 180, without requiring the application of the third party system 180 to independently interpret the user's natural-language input.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by one or more computer processors for performing any or all of the steps, operations, or processes described.

Embodiments may also relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. For instance, a computing device coupled to a data storage device storing the computer program can correspond to a special-purpose computing device. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
receiving, from a client device, a first user input;
identifying an action associated with the first user input;
accessing a command category associated with the identified action, the command category representing a characteristic of the identified action;
generating an interface for display on the client device to include the first user input and a set of placeholder text identifying the command category;
receiving, from the client device, a second user input corresponding to the command category;
modifying the set of placeholder text corresponding to the command category based on the second user input; and
enabling the client device for performing the identified action based at least on the modified set of placeholder text.

2. The method of claim 1, wherein identifying an action associated with the first user input comprises performing a natural language processing operation on the received first user input, and generating an interface for display on the client device to include the first user input and the set of placeholder text identifying the command category comprises:
identifying the command category corresponding to the processed first user input; and
determining placeholder text corresponding to the identified command category based on the processed first user input.

3. The method of claim 1, wherein generating an interface for display on the client device to include the first user input and a set of placeholder text identifying the command category comprises:
applying a machine-learned model to the identified command category and the first user input, the machine-learned model configured to select a plurality of sets of text, each set of text in the plurality associated with at least a threshold likelihood of being input by the user as the second user input;
receiving, from the machine-learned model, the plurality of sets of text;
generating the interface to include the plurality of sets of text, wherein the interface is configured to receive interactions with each set of text in the plurality; and
in response to receiving an indication of an interaction with a first set of text of the plurality, selecting the first set of text as the second user input.

4. The method of claim 1, wherein accessing the command category associated with the identified action comprises:
inputting the identified action and a set of user metadata of a user associated with the client device to a machine-learned model, wherein the machine-learned model is configured to determine the command category based on previous user actions.

5. The method of claim 1, wherein modifying the set of placeholder text corresponding to the command category based on the second user input comprises:
replacing, in the displayed interface, at least a subset of the set of placeholder text with text corresponding to the second user input.

6. The method of claim 1, wherein accessing the command category associated with the identified action comprises:
accessing hierarchically structured metadata from a third-party system, wherein the hierarchically structured metadata includes a plurality of command categories representing characteristics of actions; and
parsing the hierarchically structured metadata to select the command category based on the identified action.

7. The method of claim 6, further comprising:
extracting, from the hierarchically structured metadata, one or more further command categories that descend from the command category in the hierarchically structured metadata; and
updating the displayed interface to include the one or more further command categories.

8. The method of claim 7, further comprising:
receiving, from the client device, a third user input corresponding to a second command category of the further command categories;
further modifying the set of placeholder text based on the third user input, wherein a first subset of the modified set of placeholder text corresponds to the command category and a second subset of the modified set of placeholder text corresponds to the second command category;
selecting a subset of the further command categories that descend from the command category and the second command category in the hierarchically structured metadata; and
updating the displayed interface to remove further command categories not in the selected subset.

9. The method of claim 1, wherein the modified set of placeholder text is associated with a first key-value pair, the first key-value pair comprising the command category as a first key and a value associated with the second user input as a first value, the method further comprising:
updating the displayed interface to include one or more further command categories associated with the command category, the one or more further command categories determined based on a hierarchically structured metadata;
receiving, from the client device, a third user input corresponding to a second command category of the one or more further command categories;
further modifying the set of placeholder text based on the third user input, wherein the further modified set of placeholder text is associated with the first key-value pair and a second key-value pair comprising the second command category as a second key and a value associated with the third user input as a second value; and
further updating the displayed interface to include the first key-value pair and the second key-value pair.

10. A system comprising:
one or more computer processors; and
one or more non-transitory computer-readable storage media storing instructions that, when executed by the one or more computer processors, cause the one or more computer processors to perform operations comprising:
receiving, from a client device, a first user input;
identifying an action associated with the first user input;
accessing a command category associated with the identified action, the command category representing a characteristic of the identified action;
generating an interface for display on the client device to include the first user input and a set of placeholder text identifying the command category;
receiving, from the client device, a second user input corresponding to the command category;
modifying the set of placeholder text corresponding to the command category based on the second user input; and
enabling the client device for performing the identified action based at least on the modified set of placeholder text.

11. The system of claim 10, wherein identifying an action associated with the first user input comprises performing a natural language processing operation on the received first user input, and generating an interface for display on the client device to include the first user input and the set of placeholder text identifying the command category comprises:
identifying the command category corresponding to the processed first user input; and
determining placeholder text corresponding to the identified command category based on the processed first user input.

12. The system of claim 10, wherein generating an interface for display on the client device to include the first user input and a set of placeholder text identifying the command category comprises:
applying a machine-learned model to the identified command category and the first user input, the machine-learned model configured to select a plurality of sets of text, each set of text in the plurality associated with at least a threshold likelihood of being input by the user as the second user input;
receiving, from the machine-learned model, the plurality of sets of text;
generating the interface to include the plurality of sets of text, wherein the interface is configured to receive interactions with each set of text in the plurality; and
in response to receiving an indication of an interaction with a first set of text of the plurality, selecting the first set of text as the second user input.

13. The system of claim 10, wherein accessing the command category associated with the identified action comprises:
inputting the identified action and a set of user metadata of a user associated with the client device to a machine-learned model, wherein the machine-learned model is configured to determine the command category based on previous user actions.

14. The system of claim 10, wherein modifying the set of placeholder text corresponding to the command category based on the second user input comprises:
replacing, in the displayed interface, at least a subset of the set of placeholder text with text corresponding to the second user input.

15. The system of claim 10, wherein accessing the command category associated with the identified action comprises:
accessing hierarchically structured metadata from a third-party system, wherein the hierarchically structured metadata includes a plurality of command categories representing characteristics of actions; and
parsing the hierarchically structured metadata to select the command category based on the identified action.

16. The system of claim 15, the operations further comprising:
extracting, from the hierarchically structured metadata, one or more further command categories that descend from the command category in the hierarchically structured metadata; and
updating the displayed interface to include the one or more further command categories.

17. The system of claim 16, the operations further comprising:
receiving, from the client device, a third user input corresponding to a second command category of the further command categories;
further modifying the set of placeholder text based on the third user input, wherein a first subset of the modified set of placeholder text corresponds to the command category and a second subset of the modified set of placeholder text corresponds to the second command category;
selecting a subset of the further command categories that descend from the command category and the second command category in the hierarchically structured metadata; and
updating the displayed interface to remove further command categories not in the selected subset.

18. The system of claim 10, wherein the modified set of placeholder text is associated with a first key-value pair, the first key-value pair comprising the command category as a first key and a value associated with the second user input as a first value, the operations further comprising:
updating the displayed interface to include one or more further command categories associated with the command category, the one or more further command categories determined based on a hierarchically structured metadata;
receiving, from the client device, a third user input corresponding to a second command category of the one or more further command categories;
further modifying the set of placeholder text based on the third user input, wherein the further modified set of placeholder text is associated with the first key-value pair and a second key-value pair comprising the second command category as a second key and a value associated with the third user input as a second value; and
further updating the displayed interface to include the first key-value pair and the second key-value pair.

19. A non-transitory computer-readable storage medium storing instructions that, when executed by one or more computer processors, cause the one or more computer processors to perform operations comprising:
receiving, from a client device, a first user input;
identifying an action associated with the first user input;
accessing a command category associated with the identified action, the command category representing a characteristic of the identified action;
generating an interface for display on the client device to include the first user input and a set of placeholder text identifying the command category;
receiving, from the client device, a second user input corresponding to the command category;
modifying the set of placeholder text corresponding to the command category based on the second user input; and
enabling the client device for performing the identified action based at least on the modified set of placeholder text.

20. The non-transitory computer-readable storage medium of claim 19, wherein identifying an action associated with the first user input comprises performing a natural language processing operation on the received first user input, and generating an interface for display on the client device to include the first user input and the set of placeholder text identifying the command category comprises:
identifying the command category corresponding to the processed first user input; and
determining placeholder text corresponding to the identified command category based on the processed first user input.
